(19) United States
(12) Patent Application Publication
(10) Pub. No.: US 2008/0181504 A1
(43) Pub. Date: Jul. 31, 2008

(54) APPARATUS, METHOD, AND PROGRAM FOR DETECTING GARBLED CHARACTERS

(75) Inventor: Shinsaku Kudomi, Kanagawa-ken (JP)

Correspondence Address: IBM CORPORATION, 3039 CORNWALLIS RD., DEPT. T81 / B503, PO BOX 12195, RESEARCH TRIANGLE PARK, NC, 27709, US

(73) Assignee: INTERNATIONAL BUSINESS MACHINES CORPORATION, Armonk, NY (US)

(21) Appl. No.: 12/015,605

(22) Filed: Jan. 17, 2008

(30) Foreign Application Priority Data
Jan. 31, 2007 (JP) 2007-021874

(51) Int. Cl. G06K 9/00

(52) U.S. Cl. 382/181

(57) ABSTRACT

To enable efficient detection of a garbled character from only output data of an application, a character string addition unit adds, to input data to the application or other data, an ASCII character string, and a particular character string that follows the ASCII character string and is highly likely to be garbled. An application execution unit executes the application based on the input data to which the character strings are added. A response input unit inputs a response to data output by the application. A database stores output data outputted by the application. A garbled character detection unit detects a garbled character in output data based on the result of comparison between a character string following the ASCII character string in the output data from the application execution unit, the response input unit, and the database, and the particular character string added to the input data.

### FIELD OF THE INVENTION

The present invention relates to an apparatus, a method, and a program for detecting garbled characters. In particular, the invention relates to an apparatus, a method, and a program for detecting a garbled character that occurs during an operation of an application using a particular language.

### BACKGROUND

Software has been internationalized or globalized in recent years. The internationalization or globalization of software means that software available only in a particular language environment is enhanced so as to be available in other language environments as well. For example, it means that software that uses only English is enhanced so as to use languages (Japanese, Chinese, Korean, German, Russian, etc.) other than English.

When globalizing software in this way, a test must be conducted to determine whether or not there is a program in performing an operation of the software in a new language environment. Such a test is called a “globalization verification test.”

Besides verifying operations of the basic functions of software, the principal objectives of a globalization verification test include (1) detecting a translation omission (externalization omission), (2) detecting a garbled character, and (3) detecting a character overflow.

In globalized software, it is a common practice to previously externalize and retain a part of the software that is required to support each language. Specifically, the basic part of the software is created to run properly while a part thereof varying according to a language to be used is created to run, for example, by reading data from an external file provided for each language. It is checked in (1) whether or not such externalization has been implemented.

While a garbled character does not usually occur if the software uses only English, it may occur if the software uses a language other than English. Thus, (2) must be carried out.

Further, a character string displayed on an object such as a button may have a different length according to the language even if the character string has the same meaning. In this case, it is conceivable that even if the entire character string is displayed on the object in English, only a part of the character string is displayed on the object in a language other than English. Thus, (3) must be carried out.

While a globalization verification test has various check items as described above, (1) to (3) are carried out by visually checking the operation result of software, under the present circumstances. For example, in a Japanese language environment, these items are checked by repeatedly performing operations, such as inputting a large amount of Japanese test data and outputting data or an image including Japanese, using the basic functions of software.

Further, a globalization verification test must be conducted in great many environments. The environments here include not only language environments such as Japanese, German, Russian, and Simplified Chinese, but also environments such as types of operating system (OS) and types of character code used in a system.

Furthermore, targets to be checked in a globalization verification test are wide-ranging. If software to be tested outputs XML, CSV and log files, all these files must be checked.

In view of the foregoing, performing only a visual check to carry out (1) to (3) has imposed an enormous burden on a tester. This also holds true if only (2) (detecting a garbled character) among (1) to (3) is considered.

The garbling of a character refers to a phenomenon in which the original character is turned into a different one (a symbol that makes no sense, etc.). In a Japanese language environment, a garbled character is likely to occur if the original character is a so-called “double-byte” character, such as a hiragana character or a kanji character. A garbled character may occur when a character is read using a character code different from the original character code or when a character code for reading a character correctly is not prepared.

As a method for detecting a garbled character, it has been known to compare inputted data and outputted data (for example, see Japanese Patent Application Publication No. 2006-185388). In Japanese Patent Application Publication No. 2006-185388, it is disclosed that if data different from image data that a terminal has instructed a printer to print begins to be printed due to occurrence of a garbled character or for other reasons, the print is automatically stopped to save the recording paper.

As another method for detecting a garbled character, it has also been known to check outputted data against registered information (for example, see Japanese Patent Application Publication No. 2000-82025 and Japanese Patent Application Publication No. 2006-163578). In Japanese Patent Application Publication No. 2000-82025, it is disclosed that it is determined whether or not the character code of each character in text data falls within the scope of a character set currently being used and that if an electronic mail has been determined to include a garbled character, the electronic mail is prevented from being read. In Japanese Patent Application Publication No. 2006-163578, it is disclosed that if a font specified in print data is not available at the time of printing, the print data is converted into intermediate print data in which the specified font is replaced with an available font and that if a character string obtained when the intermediate print data is developed into a raster image is not registered with a dictionary, the character string is detected as a location that has a garbled character.

As yet another method for detecting a garbled character, it has also been known to add a tag set to application data (for example, see Japanese Patent Application Publication No. 2002-109475). In Japanese Patent Application Publication No. 2002-109475, it is disclosed that a device serving to output application data generates application data with correction information, in which a predetermined portion is replaced with a tag set, and that a device serving to receive application data identifies the tag set included in the application data with the correction information to detect an error or a garbled character in the data.

As described above, various methods for detecting a garbled character have been proposed. However, if an application is tested on the basis of an operation thereof, the method disclosed in Japanese Patent Application Publication No. 2006-185388 has a problem that it is difficult to compare input data and output data.

In general, an application runs on the basis of a great amount of data and outputs a great amount of data. Therefore, it is difficult to determine which piece of the input contributes to the output data.

In the methods for checking output data against registered information as disclosed in Japanese Patent Application Publication No. 2000-82025 and Japanese Patent Application Publication No. 2006-163578, there is no need to compare input data to output data. However, those methods have a problem that only a garbled character of a type detectable on the basis of information that can previously be registered is detectable.

The method disclosed in Japanese Patent Application Publication No. 2002-109475 has room for further improvement in that efficiently adding correction information to input data allows a garbled character to be more efficiently detected.

### SUMMARY

The present invention allows detection of a garbled character using an American Standard Code for Information Interchange (ASCII) character string and a particular character string following the ASCII character string. Specifically, according to an first aspect of the invention, an apparatus for detecting a garbled character that occurs during an operation of an application using a particular language includes an acquisition unit configured to acquire output data outputted after an operation of the application based on input data including an ASCII character string and a particular following the ASCII character string; and a recognition unit configured to recognize whether or not a garbled character has occurred in the output data on the basis of a result of a comparison between a character string following the ASCII character string in the output data acquired by the acquisition unit and the particular character string included in the input data.

In the apparatus according to the first aspect of the invention, the ASCII character string may be a character string that does not usually appear in the output data. The particular character string may be a character string including a character determined to be highly likely to be garbled due to a programming language used to create the application or due to an environment in which the application runs.

The apparatus according to the first aspect of the invention may further include an output unit configured to, if there is a difference between a character string following the ASCII character string in the output data acquired by the acquisition unit and the particular character string included in the input data, output information indicating that a garbled character has occurred in the output data.

The apparatus according to the first aspect of the invention may further include an output unit configured to, if there is a difference between a character string following the ASCII character string in the output data acquired by the acquisition unit and the particular character string included in the input data, output information indicating that a garbled character has occurred in the output data and information on a location at which the garbled character has occurred.

The present invention may also be viewed as a method for detecting a garbled character using an ASCII character string and a particular character string following the ASCII character string. Specifically, according to a second aspect of the invention, a method for detecting a garbled character that occurs during an operation of an application using a particular language includes the steps of adding, to input data, an ASCII character string and a particular character string that follows the ASCII character string and is specific to the particular language; operating the application on the basis of the input data; and recognizing whether or not a garbled character has occurred in output data outputted after the operation of the application, by comparing a character string following the ASCII character string in the output data with the particular character string previously stored in a predetermined storage device.

The present invention may further be viewed as a computer program for detecting a garbled character using an ASCII character string and a particular character string following the ASCII character string. Specifically, according to a third aspect of the invention, a program for detecting a garbled character that occurs during an operation of an application using a particular language causes a computer to execute the functions of acquiring output data outputted after an operation of the application based on input data including an ASCII character string and a particular character string that follows the ASCII character string and is specific to the particular language; and recognizing whether or not a garbled character has occurred in the output data on the basis of a result of a comparison between a character string following the ASCII character string in the output data and the particular character string included in the input data.

### BRIEF DESCRIPTION OF THE DRAWINGS

FIG. 1 is a diagram showing an example of a system configuration according to an embodiment of the present invention.

FIG. 2 is a diagram showing another example of the system configuration according to this embodiment.

FIG. 3 is a diagram showing the outline of detection of a garbled character according to this embodiment.

FIG. 4 is a block diagram showing a configuration example of a character string addition unit according to this embodiment.

FIG. 5 is a flowchart showing an operation example of the character string addition unit according to this embodiment.

FIG. 6 is a block diagram showing a configuration example of a garbled character detection unit according to this embodiment.

FIG. 7 is a flowchart showing an operation example of the garbled character detection unit according to this embodiment.

FIG. 8 is a diagram showing a computer hardware configuration to which this embodiment is applicable.

### DETAILED DESCRIPTION

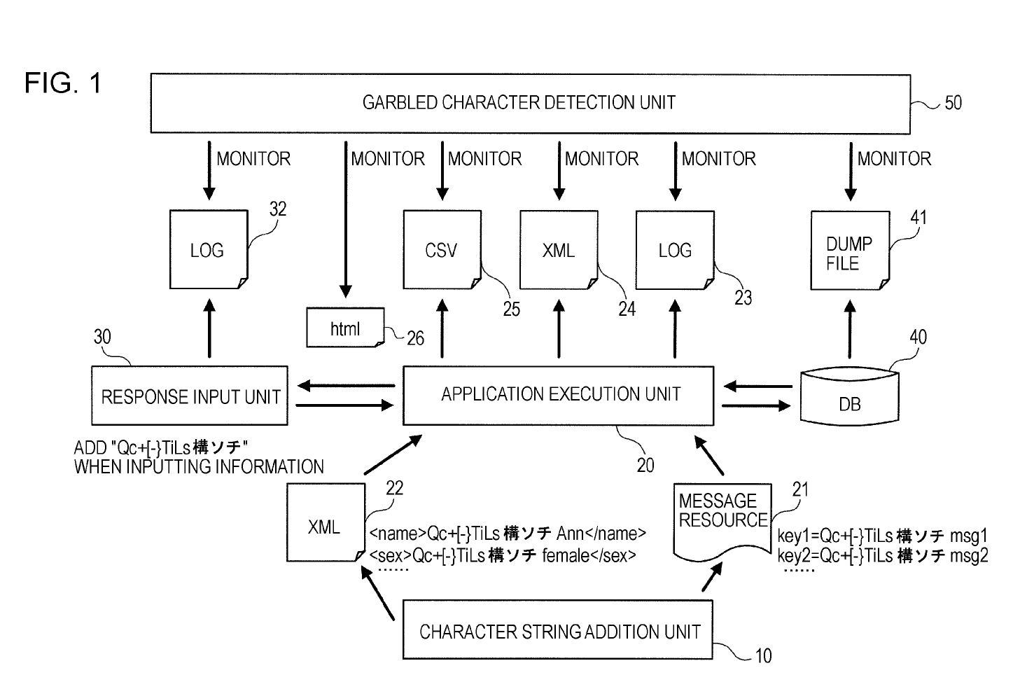

FIG. 1 a block diagram showing an example of a system configuration according to this embodiment. As shown in the diagram, this system configuration example includes a character string addition unit 10 that adds a character string for detecting a garbled character to input data for an application to be tested (hereafter simply referred to as “the application”) and an application execution unit 20 that executes the application on the basis of the input data to which the character string is added. It also includes a response input unit 30 that inputs a response to information outputted by executing the application and a database 40 that stores data outputted by executing the application. It further includes a garbled character detection unit 50 that detects a garbled character from output data or the like outputted by executing the application.

In this embodiment, the application is assumed to be the one using Japanese and will be tested with respect to whether or not it runs properly in a Japanese environment.

Installed into the character string addition unit 10 is a “character string addition tool” that is software for adding a character string. This character string addition tool inserts “Qc+[−}TiLs□□□” serving as a character string for detecting a garbled character into predetermined locations in a message resource 21 and an XML file 22, both of which are pieces of data to be inputted to the application. This character string includes “Qc+[−}TiLs”, which is an ASCII character string, and “□□□”, which is a particular character string specific to a language to be tested (Japanese in this embodiment). As the ASCII character string, a special ASCII character string that does not usually appear otherwise (for example, an ASCII character string that does not usually appear in the data to be tested) is used. As the particular character string, a character string including “characters that are determined to be especially highly likely to be garbled due to characteristics of the application” is used. The characters determined to be highly likely to be garbled here refer to characters that are generally considered as highly likely to be garbled due to a programming language used to create the application or the environment in which the application runs or for other reasons.

First, an example of a character that is determined to be highly likely to be garbled due to the programming language will be provided. For example, assume that the application is written using Perl and that a regular expression is used in a process performed by the application. In this case, a character such as a kanji or a hiragana, whose second byte is the same as “5c” (\), “5e” (̂), “5b” ([) or the like may be misidentified as a special character in the regular expression. Therefore, such a character is considered as highly likely to be garbled.

Next, an example of a character that is determined to be highly likely to be garbled due to the environment in which the application runs will be provided. For example, with regard to an application that runs on a platform in which the Shift-JIS is used as a Japanese character code as in Windows®, characters such as “□”, “□”, and “□” whose second byte is “5c”, are considered as highly likely to be garbled. As for European languages, such as German and French, characters that are not included in ASCII characters and have an accent are considered as highly likely to be garbled. Such characters are mapped as two bytes or three bytes in UTF-8 (UCS Transformation Format-8), those characters may be garbled if outputted without undergoing code conversion.

The application execution unit 20 is a unit for executing the application using the message resource 21 and the XML file 22, to which “Qc+[−}TiLs□□□” serving as a character string for detecting a garbled character is added, as input data. As shown in the diagram, execution of the application by the application execution unit 20 results in outputting of a log 23, an XML file 24, and a CSV file 25. Also, an HTML file is sent through a communication line so that data is written to a database 40 to be discussed later.

The response input unit 30 is a unit for receiving the HTML file 26 sent through the communication line by the application, making a display on the basis of the received file, and inputting response information to the display. Specifically, a browser for viewing Web pages is previously installed into the response input unit 30. This browser reads and interprets the HTML file 26 and displays a content indicated therein, for example, a form. When the operator inputs information into input items on the form using a keyboard or the like and sends the information, the inputted information is processed so as to output a log 32. Also in this case, “Qc+[−}TiLs□□□” serving as a character string for detecting a garbled character is added to the information inputted by the operator. For example, it is preferable to previously assign the function for adding this character string to information to be inputted, to a particular key on the keyboard and to add this character string to the input information by pressing down the key when inputting the information.

The database 40 accumulates data outputted by executing the application by the application execution unit 20. The contents of the database 40 are outputted as a dump file 41 therefrom, for example, using a database management system (DBMS) function.

Installed into the garbled character detection unit 50 is a “garbled character detection monitor,” which is software for detecting a garbled character. This garbled character detection monitor detects whether or not a garbled character has occurred in the log 23, the XML file 24, and/or the CSV file 25. It also detects whether or not a garbled character has occurred in the HTML file 26 obtained by monitoring data communications through the communication line. It further monitors the log 32 outputted by the response input unit 30 and the dump file 41 outputted on the basis of the database 40 to detect whether or not a garbled character has occurred in the log and/or the file. In this embodiment, the log 32 is used as an example of data generated by an operation performed by the operator on the basis of data outputted from the application. The dump file 41 is used as an example of data generated by an operation performed by a program on the basis of data outputted from the application.

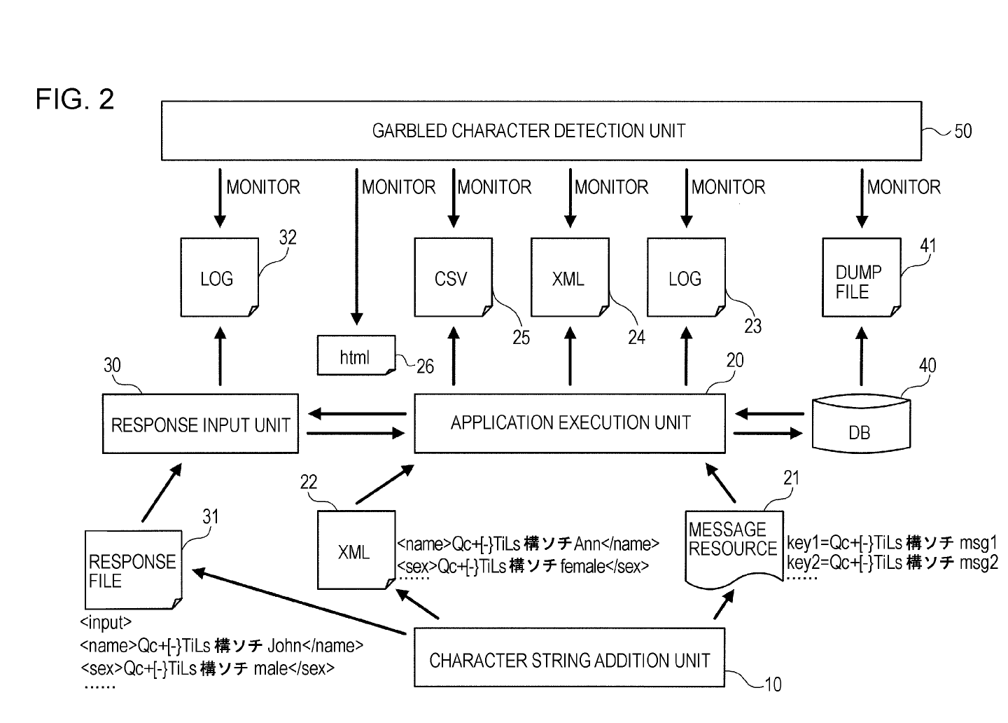

FIG. 2 is a block diagram showing another example of a system configuration according to this embodiment. As shown in the diagram, like the system configuration example shown in FIG. 1, this system configuration example includes the character string addition unit 10 for adding a character string for detecting a garbled character to input data to the application and the application execution unit 20 for executing the application on the basis of the input data to which a character string is added. It also includes the response input unit 30 for inputting a response to information outputted by executing the application and the database 40 for storing data outputted by executing the application. It further includes the garbled character detection unit 50 for detecting a garbled character from output data or the like outputted by executing the application.

The system configuration example shown in FIG. 2 is different from that shown in FIG. 1 in that the response input unit 30 automatically inputs a response by reading a previously created response file 31 rather than inputs a response using key entry performed by the operator. Specifically, in the response input unit 30, the browser reads and interprets the HTML file 26, and displays a content indicated therein, for example, a form. If instructed to read the response file 31, the response input unit 30 sequentially receives and processes the contents of the response file 31 and then outputs the log 32. Also in this case, when the response file 31 is written, “Qc+[−}TiLs□□□” serving as a character string for detecting a garbled character is added to it.

Next, the outline of detection of a garbled character in this embodiment will be described.

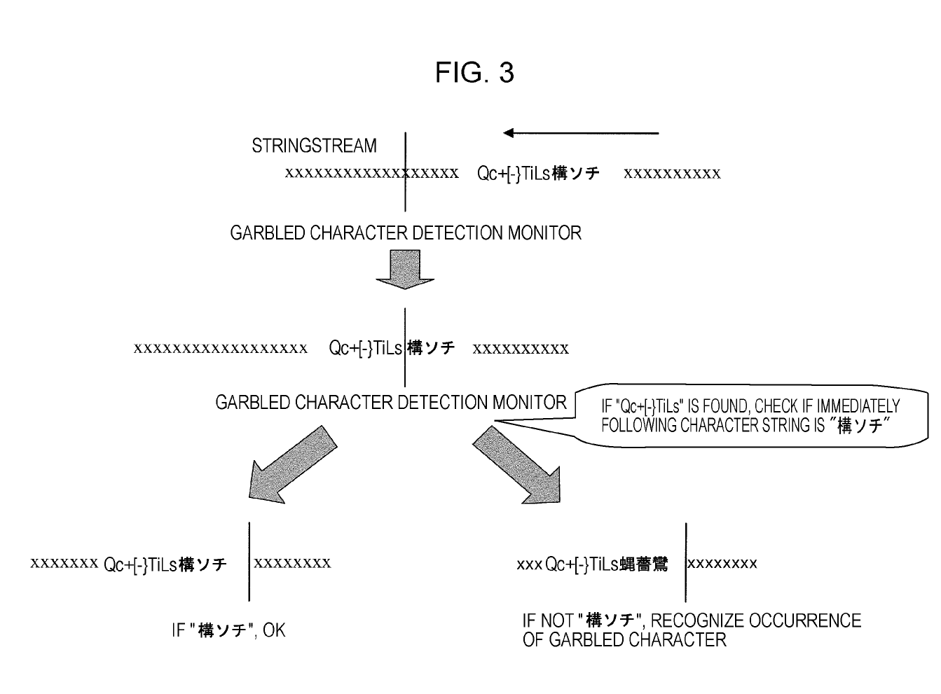

FIG. 3 is a diagram showing the flow of detection of a garbled character. As shown in the diagram, the garbled character detection monitor scans a string stream in which “Qc+[−}TiLs□□□” is inserted as a character string for detecting a garbled character, and finds “Qc+[−}TiLs”, which is a portion corresponding to the ASCII character string. Then, the garbled character detection monitor determines whether or not a character string immediately following the ASCII character string “Qc+[−}TiLs” is “□□□”, which is a predetermined particular character string that is highly likely to be garbled. If the immediately following character string is “□□□”, it is determined that the character string has no garbled character, as indicated by the lower-left-directed arrow. Otherwise, it is determined that the character string has a garbled character(s), as indicated by the lower-right-directed arrow.

Now, the configuration and operation of a system that detects a garbled character in this manner will be described in detail.

Addition of Character String will now be described.

First, the character string addition unit 10 for adding a character string will be described.

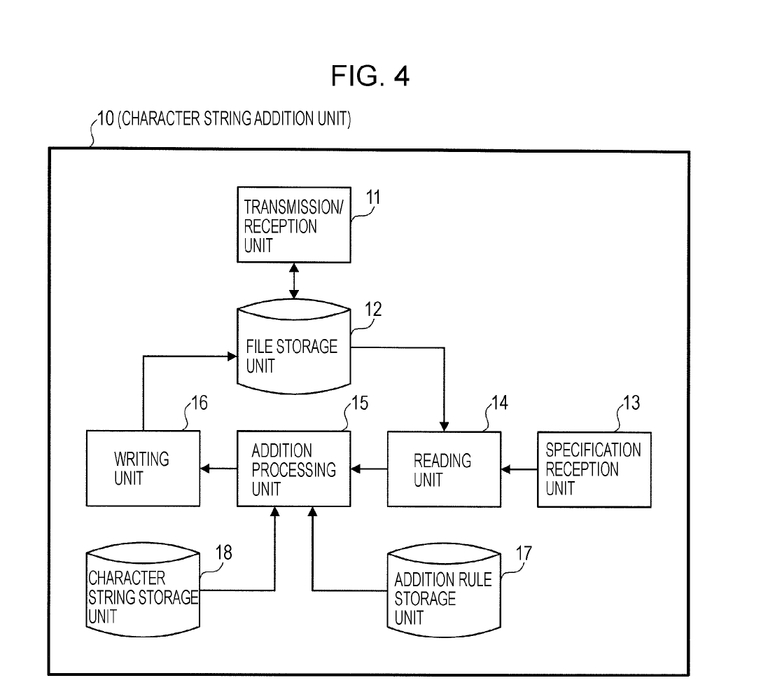

FIG. 4 is a block diagram showing a configuration example of the character string addition unit 10 according to this embodiment. As shown in the diagram, the character string addition unit 10 includes a transmission/reception unit 11, a file storage unit 12, a specification reception unit 13, a reading unit 14, an addition processing unit 15, a writing unit 16, an addition rule storage unit 17, and a character string storage unit 18.

The transmission/reception unit 11 receives a file to which a character string is to be added and transmits the file to which the character string has been added. In FIG. 1, the message resource 21 and XML file 22 are shown as files to which a character string is to be added, and in FIG. 2, the response file 31 is further shown as such a file. Therefore, the transmission/reception unit 11 receives the message resource 21, the XML file 22, and the response file 31, for example, from a tester's terminal (not shown). After adding a character string, the transmission/reception unit 11 transmits the message resource 21 and the XML file 22 to the application execution unit 20, and the response file 31 to the response input unit 30.

The file storage unit 12 stores a file received by the transmission/reception unit 11 and a file to be transmitted by the transmission/reception unit 11 (a file to which a character string has been added).

The specification reception unit 13 receives the specification or designation of a file to which a character string is to be added, among files stored in the file storage unit 12. For example, if an operation for selecting a file to which a character string is to be added can be performed on a screen provided by the character string addition tool, the specification reception unit 13 receives information on such a selection operation performed by the operator.

The reading unit 14 reads a file identified by the specification received by the specification reception unit 13, from the file storage unit 12.

The addition processing unit 15 adds a character string to the file read by the reading unit 14 in accordance with a rule (hereinafter referred to as an “addition rule”) that should be used when the character string is added.

The writing unit 16 writes the file to which the character string has been added by the addition processing unit 15, back to the file storage unit 12.

The addition rule storage unit 17 stores a rule used when the addition processing unit 15 adds a character string to a file. This addition rule is defined according to the type of a file to which a character string is to be added. For example, with regard to the message resource 21, it is preferable to store a rule that a character string should be put immediately following the first “=” in each statement. If it is previously found that only a statement starting with “keyn=” (n=1, 2, . . . ) of statements included in the message resource 21 affects output data, it is preferable to store a rule that a character string should be put immediately following “keyn=” (n=1, 2, . . . ). As for an XML format file such as the XML file 22 or response file 31, it is preferable to define as an addition rule an element to which a character string is to be added, among elements enclosed by Start and End tags.

The character string storage unit 18 stores a character string to be added to a file. The character string stored therein is a character string, such as “Qc+[−}TiLs□□□”, that includes an ASCII character string and a particular character string that is highly likely to be garbled. Note that this character string may directly be written in a program that causes the addition processing unit 15 to execute a process rather than stored in the character string storage unit 18.

Next, the operation of the character string addition unit 10 will be described in detail.

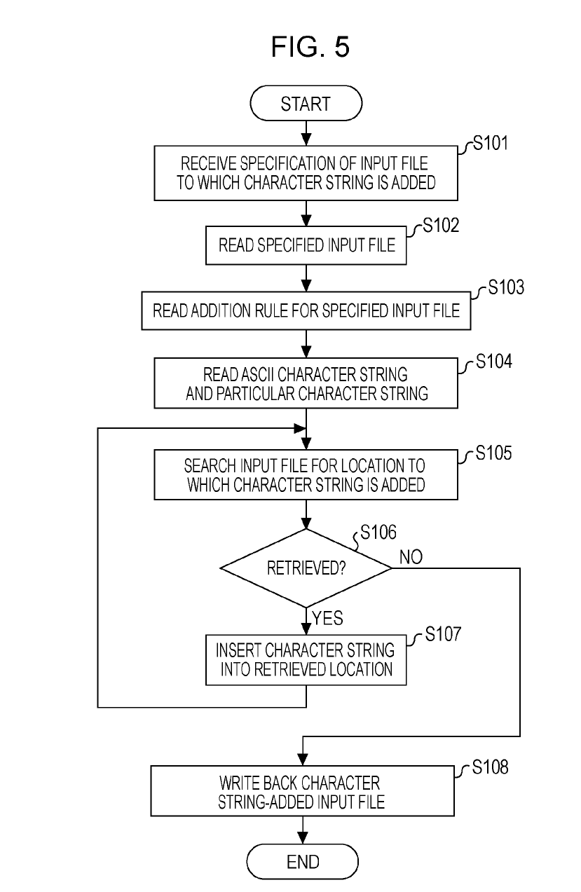

FIG. 5 is a flowchart detailing an operation example of the character string addition unit 10. Here, assume that a character string is added to an input file to the application. Also, assume that some files to which a character string is to be added are previously received by the transmission/reception unit 11 and stored in the file storage unit 12.

In the character string addition unit 10, first, the specification reception unit 13 receives the specification of an input file to which a character string is to be added (step 101). The specification reception unit 13 passes information identifying the specified input file to the reading unit 14. The reading unit 14 reads the specified file from the file storage unit 12 (step 102). Thus, the read input file is developed in a memory used by the addition processing unit 15.

When the input file is developed in the memory in this way, the addition processing unit 15 reads an addition rule for this input file from the addition rule storage unit 17 (step 103). Also, it reads an ASCII character string and a particular character string to be added to the input file, from the character string storage unit 18 (step 104).

Thereafter, the addition processing unit 15 scans the input file developed in the memory so as to search for a location that is defined as a location to which a character string is to be added in accordance with the addition rule (step 105). Then, it is determined whether or not such a location has been retrieved (step 106). If it is determined that such a location has been retrieved, the character string is inserted into the retrieved location (step 107). Then, the process returns to step 105, and the search for a location to which the character string is to be added and the insertion of the character string are continued until the determination in step 106 results in “No”. If the determination in step 106 results in “No”, there is no more location to which the character string is to be added. Thus, the addition of the character string ends, and the input file is written back to the file storage unit 12 (step 108).

Now the garbled character detection unit 50 for detecting a garbled character will be described.

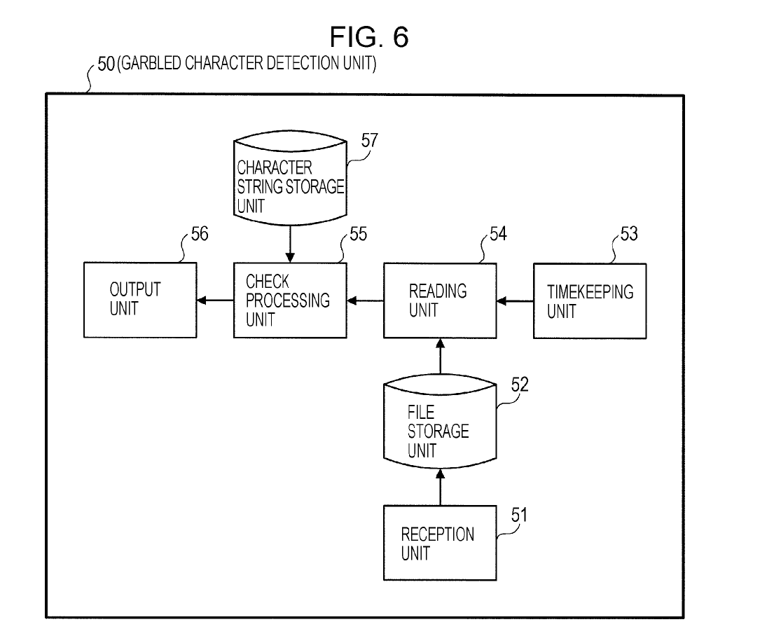

FIG. 6 is a block diagram showing a configuration example of the garbled character detection unit 50 according to this embodiment. As shown in the diagram, the garbled character detection unit 50 includes a reception unit 51, a file storage unit 52, a timekeeping unit 53, a reading unit 54, a check processing unit 55, an output unit 56, and a character string storage unit 57.

The reception unit 51 receives files to be checked, such as one outputted by executing the application by the application execution unit 20, one outputted by the response input unit 30, and one outputted using DBMS on the basis of the database 40. The reason why the reception unit 51 is provided is that it is conceivable that a file to be checked is typically received from a device connected to the garbled character detection unit 50 via a communication line. For example, the HTML file 26 shown in FIGS. 1 and 2 is acquired by capturing an HTTP packet passing through the communication line by a monitor (not shown). In this case, the HTML file 26 is typically transmitted from the monitor to the garbled character detection unit 50 via the communication line. The reception unit 51 receives the HTML file 26 transmitted in this manner. However, a file to be checked need not be always received via a communication line. For example, a file to be checked may be received via a storage means such as a semiconductor memory or a magnetic disk device. In this sense, the reception unit 51 is considered as an example of an acquisition means for acquiring output data outputted after the operation of the application.

The file storage unit 52 stores a file to be checked received by the reception unit 51. The timekeeping unit 53 retains the current time and instructs the reading unit 54 to read a file periodically and pass the read file to the check processing unit 55. According to the instruction provided by the timekeeping unit 53, the reading unit 54 reads an updated portion of a file updated since the last operation, from the file storage unit 52.

The check processing unit 55 checks whether or not the read file portion has a garbled character. In this embodiment, the check processing unit 55 is considered as an example of a recognition means for recognizing whether or not a garbled character has occurred.

The output unit 56 outputs the result of the check conducted by the check processing unit 55. The output here may be display of the check result on a display included in the garbled character detection unit 50 or printing of the check result using a printer connected to the garbled character detection unit 50.

The character string storage unit 57 stores a character string prepared to detect a garbled character. The character string to be stored therein is the same as that stored in the character string storage unit 18 of the character string addition unit 10. Specifically, it is a character string, such as “Qc+[−}TiLs□□□”, that includes an ASCII character string and a particular character string that is highly likely to be garbled. Note that this character string may directly be written in a program that causes the check processing unit 15 to execute a process rather than stored in the character string storage unit 57.

Next, the operation of the garbled character detection unit 50 will be described in detail.

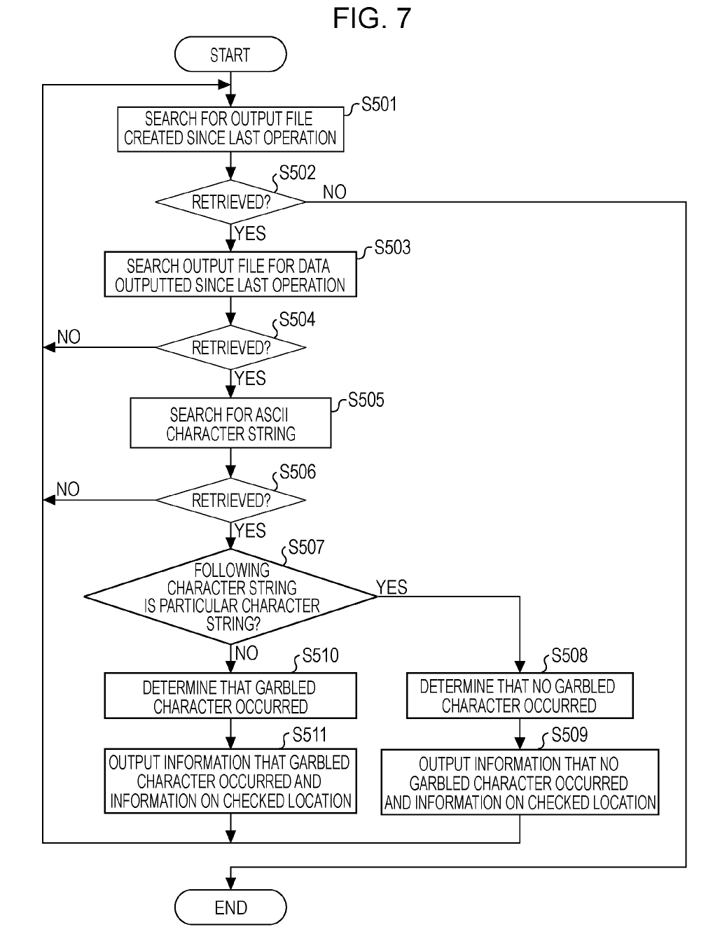

FIG. 7 is a flowchart detailing an operation example of the garbled character detection unit 50. Here, assume that a garbled character is detected in an output file from the application. Also assume that after reception of the output file from the application by the reception unit 51, the timekeeping unit 53 has instructed the reading unit 54 to start an operation with the output file stored in the file storage unit 52.

Once instructed to start an operation, the reading unit 54 searches the file storage unit 52 for an output file created since the last operation (step 501). Then, it is determined whether or not such an output file has been retrieved (step 502). If such an output file has been retrieved, the reading unit 54 searches the retrieved output file for data outputted since the last operation (step 503). Then, it is determined whether or not such data has been retrieved (step 504). If such data has been retrieved, the reading unit 54 reads the data and passes it to the check processing unit 55. If such an output file has not been retrieved in step 502, it is determined that there is no output file created since the last operation, and the current operation ends. If such data has not been retrieved in step 504, it is determined that there is no data outputted since the last operation in the output file, and the process with respect to the output file ends. Then, the current operation returns to step 501 and the process with respect to the subsequent output file is performed.

Next, the check processing unit 55 searches the data passed by the reading unit 54 for an ASCII character string (step 505). The character string to be searched for here is that read from the character string storage unit 57 by the check processing unit 55. Then, it is determined whether or not such an ASCII character string has been retrieved (step 506). If such an ASCII character string has been retrieved, the check processing unit 55 determines whether or not a character string following the ASCII character string is a particular character string (step 507). The particular character string to be compared here is that read from the character string storage unit 57 by the check processing unit 55.

If the character string following the ASCII character string is the particular character string, the check processing unit 55 determines that no garbled character has occurred (step 508). Then, it provides the output unit 56 with information to that effect and information on the currently checked location (step 509). Thus, the output unit 56 outputs the information indicating that no garbled character has occurred and the information on the checked location (step 509).

On the other hand, if the character string following the ASCII character string is not the particular character string, the check processing unit 55 determines that a garbled character(s) has occurred (step 510). Then, it provides the output unit 56 with information to that effect and information on the currently checked location (step 510). Thus, the output unit 56 outputs the information indicating that a garbled character(s) has occurred and the information on the checked location (step 511).

In this operation example, for each checked location in which the ASCII character string has been retrieved, information on whether or not a garbled character has occurred and information on the checked location is outputted. However, these pieces of information may be outputted only if a garbled character has occurred. Only information on whether or not a garbled character has occurred (for example, information on the frequency at which a garbled character occurs) may be outputted without outputting information on the checked location.

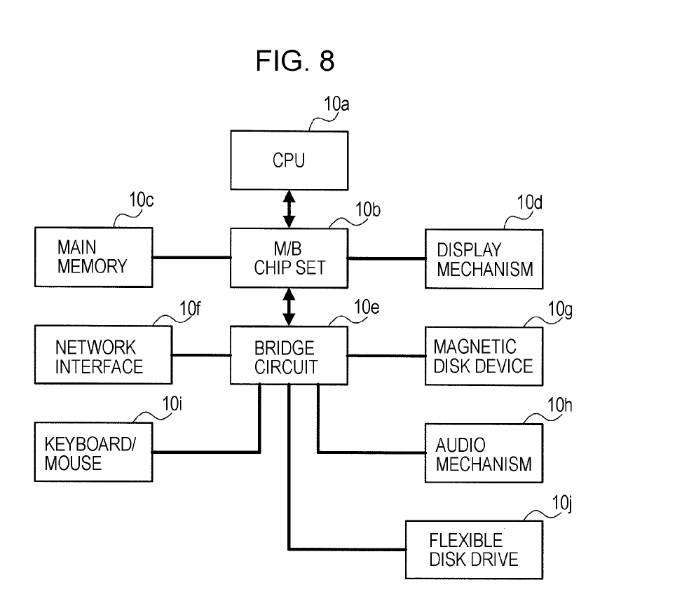

Lastly, a preferable computer hardware configuration to which this embodiment is applicable will be described. FIG. 8 is a diagram showing an example of such a computer hardware configuration. As shown in the diagram, a computer includes a central processing unit (CPU) 10a serving as a computation means, a main memory 10c coupled to the CPU 10a via a motherboard (M/B) chip set 10b, and a display mechanism 10d coupled to the CPU 10a via the M/B chip set 10b as well. Coupled to the M/B chip set 10b via a bridge circuit 10e are a network interface 10f, a magnetic disk device (HDD) 10g, an audio mechanism 10h, a keyboard/mouse 10i, and a flexible disk drive 10j.

In FIG. 8, these components are connected to one another via buses. For example, the CPU 10a and the M/B chip set 10b, and the M/B chip set 10b and the main memory 10c are connected via a CPU bus. The M/B chip set 10b and the display mechanism 10d may be connected via an Accelerated Graphics Port (AGP). If the display mechanism 10d includes a Peripheral Component Interconnect (PCI) Express-enabled video card, the M/B chip set 10b and this video card are connected via a PCI Express (PCIe) bus. The bridge circuit 10e and the network interface 10f are connected, for example, using a PCI Express bus. The bridge circuit 10e and the magnetic disk device 10g are connected, for example, using a serial AT attachment (ATA) bus, a parallel transfer ATA bus, or a PCI bus. The bridge circuit 10e and the keyboard/mouse 10i, and the bridge circuit 10e and the flexible disk drive 10j are connected using a Universal Serial Bus (USB).

The present invention in its entirety may be realized using hardware or software. This invention may also be realized using both of hardware and software. Further, this invention may be realized as a computer, a data processing system, or a computer program. Such a computer program may be stored in a computer-readable medium and provided. As such a computer-readable medium, it is conceivable to use an electronic, magnetic, optical, electromagnetic, or infrared or semiconductor system (device) or propagation medium. More specifically, such computer-readable media include a semiconductor or solid state storage device, a magnetic tape, a detachable computer diskette, a random access memory (RAM), a read-only memory (ROM), a rigid magnetic disk, and an optical disk. Among currently available optical disks are a compact disc-read only memory (CD-ROM), a compact disc-read/write (CD-R/W), and a digital versatile disc (DVD).

As described above, in this embodiment, a garbled character is detected by previously adding, to an input file, an ASCII character string and a particular character string that follows the ASCII character string and is highly likely to be garbled and determining whether or not the character string following the ASCII character string remains the particular character string in an output file.

What is claimed is:

1. An apparatus for detecting a garbled character that occurs during an operation of an application using a particular language, the apparatus comprising:
an acquisition unit configured to acquire output data outputted after an operation of the application based on input data including an American Standard Code for Information Interchange (ASCII) character string and a particular character string specific to the particular language, the particular character string following the ASCII character string; and
a recognition unit configured to recognize whether or not a garbled character has occurred in the output data on the basis of a result of a comparison between a character string following the ASCII character string in the output data acquired by the acquisition unit and the particular character string included in the input data.

2. The apparatus according to claim 1, wherein
the ASCII character string is a character string that does not usually appear in the output data, and
the particular character string is a character string including a character determined to be highly likely to be garbled due to a programming language used to create the application or due to an environment in which the application runs.

3. The apparatus according to claim 1, wherein
if the output data is transmitted via a communication line, the acquisition unit acquires the output data by monitoring data communications via the communication line.

4. The apparatus according to claim 1, wherein
the acquisition unit acquires, as the output data, data generated according to an operation of an operator or an operation of a program, each of the operations being based on data outputted from the application.

5. The apparatus according to claim 1, further comprising
an output unit configured to, if there is a difference between a character string following the ASCII character string in the output data acquired by the acquisition unit and the particular character string included in the input data, output information indicating that a garbled character has occurred in the output data.

6. The apparatus according to claim 1, further comprising
an output unit configured to, if there is a difference between a character string following the ASCII character string in the output data acquired by the acquisition unit and the particular character string included in the input data, output information indicating that a garbled character has occurred in the output data and information on a location at which the garbled character has occurred.

7. A method for detecting a garbled character that occurs during an operation of an application using a particular language, the method comprising the steps of:
adding, to input data, an American Standard Code for Information Interchange (ASCII) character string and a particular character string specific to the particular language, the particular character string following the ASCII character string;
operating the application on the basis of the input data; and
recognizing whether or not a garbled character has occurred in output data outputted according to the operation of the application, by comparing a character string following the ASCII character string in the output data with the particular character string previously stored in a predetermined storage device.

8. The method according to claim 7, further comprising the step of outputting information indicating that a garbled character has occurred in the output data and information on a location in which the garbled character has occurred if there is a difference between the character string following the ASCII character string in the output data outputted according to the operation of the application and the particular character string stored in the predetermined storage device.

9. A computer program product for detecting a garbled character that occurs during an operation of an application using a particular language, the program comprising computer code tangibly embodied in a memory, said computer code causing a computer to execute the functions of:
acquiring output data outputted after an operation of the application based on input data including an American Standard Code for Information Interchange (ASCII) character string and a particular character string specific to the particular language, the particular character string following the ASCII character string; and
recognizing whether or not a garbled character has occurred in the output data on the basis of a result of a comparison between a character string following the ASCII character string in the output data and the particular character string included in the input data.

10. The computer program product according to claim 9, wherein
the ASCII character string is a character string that does not usually appear in the output data, and
the particular character string is a character string including a character determined to be highly likely to be garbled due to a programming language used to create the application or due to an environment in which the application runs.
